(19) United States
(12) Patent Application Publication
(10) Pub. No.: US 2002/0063361 A1
(43) Pub. Date: May 30, 2002

(54) Laser processing of alumina or metals on or embedded therein

(76) Inventor: Kevin P. Fahey, Portland, OR (US)

Correspondence Address: STOEL RIVES LLP, 900 SW FIFTH AVENUE, SUITE 2600, PORTLAND, OR, 97204, US

(21) Appl. No.: 09/957,633

(22) Filed: Sep. 19, 2001

Related U.S. Application Data
(60) Provisional application No. 60/233,914, filed on Sep. 20, 2000.
(60) Provisional application No. 60/233,913, filed on Sep. 20, 2000.

(51) Int. Cl. B23K 26/14

(52) U.S. Cl. 264/400; 219/121.67

(57) ABSTRACT

UV laser output (190) is employed to sever a conductive shunt (106) formed across conductive components, such as read pads, of a magnetic head (10) of a slider (14) without damaging underlayers sensitive to UV laser light. An exemplary conductive shunt (106) is preferably fabricated from gold other appropriate metal(s) and forms a closed circuit with the magnetic head sensor (20) to protect it from damage from electrostatic discharge during polishing and other magnetic head processing steps. The conductive shunt (106) may be on or embedded in an alumina layer(44), permitting shunting at different workpiece layers and permitting the shunting to be present through more subsequent process steps and removed after singulation or during final assembly.

This patent application derives priority from U.S. Provisional Application No. 60/233,914, filed Sep. 20, 2000 and from U.S. patent application No. 09/803,382, filed Mar. 9, 2001, which claims priority from U.S. Provisional Application No. 60/233,913, filed Sep. 20, 2000.

### TECHNICAL FIELD

The present invention relates to a laser-based method for severing a metallic shunt between contact pads or other metal features on the surface of or embedded in alumina of a magnetic head of a slider and, in particular, to such a method that employs an ultraviolet laser output having at a predetermined wavelength a power density of sufficient magnitude to sever such a metallic shunt positioned above, or embedded in, a alumina characterized by height and absorption sensitivity that is sufficient to prevent the laser output from impinging and damaging layers underlying the alumina layer.

### BACKGROUND OF THE INVENTION

FIG. 1 is a perspective view of a wafer deposited end 12 of a prior art magneto-resistive (MR) head 10 of a slider 14, and FIG. 2 is a cross-sectional view of slider 14 with its thin film MR sensor 20 on wafer-deposited end 12 oriented toward a magnetic medium of a direct access storage device (DASD), such as a magnetic disk 18. The background of invention proceeds only by way of example to particular types of MR heads 10; however, skilled persons will appreciate that the following description is germane to many different types of slider magnetic heads, including but not limited to (GMR) and tunneling magneto-resistive (TMR) heads. With reference to FIGS. 1 and 2, MR sensors 20 are commonly used as read elements in MR heads 10 for sensing recorded signals on disks 18. MR sensor 20 typically includes a thin stripe of conductive magnetic material, or a stack of magnetic, conductive, and/or nonconductive layers such as in GMR or TMR, which is typically less than or equal to 1 micron (μm) wide, 1 μm tall or high, and 100 nm thick. The width and thickness of the MR stripe are exposed at an exterior air-bearing surface 26 of MR head 10 while the height is buried in the head body.

When disk 18 is rotated adjacent the stripe, magnetic fields from disk 18 cause the stripe to change its resistance. A sense current conducted through the MR stripe changes its magnitude proportionally to the change in resistance. The magnitude changes are then processed by channel electronics into playback signals representing information stored on disk 18.

A typical slider 14 includes a non-magnetic substrate 22, such as a ceramic material which is typically alumina/titanium carbide (Al₂O₃/TiC) (also commonly referred to as AlTiC), that is about 300 μm deep and forms a majority of the body of slider 14. Substrate 22 generally, therefore, defines air-bearing surface 26, which has an aerodynamic configuration suitable for lifting slider 14 a desired distance above the surface of disk 18 as it rotates. The MR stripe and other thin film layers of MR head 10 are formed by plating, sputtering, and/or various masking techniques which are well known in the art. An exemplary technique for generating the layers of a slider having a thin-film magnetic head is described in U.S. Pat. No. 4,652,954. MR head 10 has a read head portion and a write head portion. The read head portion includes MR sensor 20 and accompanying thin film leads 46 and 48 which are sandwiched between first and second gap layers 50 and 52 which are, in turn, sandwiched between first and second thin film shield layers 54 and 56. Leads 46 and 48 are employed for transmitting a sense current through MR sensor 20 and terminate at a pair of exterior read pads 34 and 36 by conductive leads 38 and 40. Read pads 34 and 36 are typically made from gold, copper, or other suitable conductive metallic materials or alloys. Read pads 34 and 36 typically have a surface area of a few hundred microns square to larger than millimeters square and a depth dimension of about 10-100 μm or more, and they are typically spaced apart by a separation dimension of at least about 10-20 μm and typically less than 300 μm. Read pads 34 and 36 may be partly embedded in (as shown in FIG. 2), or entirely on exterior surface 42 of (as shown in FIG. 1), an overcoat layer 44 that is typically 20-50 μm of an alumina (Al₂O₃). Read pads 34 and 36 are exposed for connection to drive electronics (not shown).

The write head portion of MR head 10 includes an insulation stack of layers 58, 60, and 62 sandwiched between first and second magnetic pole pieces 56 and 66. Layers 58, 60, and 62 are typically made of a polymeric materials, such as hard-baked photoresist, and insulate a coil layer 64. Write pads 74 and 76 are connected to coil layer 64 for inducing write signals into the write head portion of MR head 10. Write pads 74 and 76 typically are fabricated from the same materials and in the same dimensions as read pads 34 and 36.

In this embodiment, the second shield layer of the read head and the first pole piece of the write head are the same layer 56. This type of head is referred to as a merged MR head 10. When the second shield layer 56 and the first pole piece 56 are separate layers, MR head 10 is referred to as a piggyback MR head 10. Either type of head is applicable to the present invention. The first and second pole pieces 56 and 66 terminate in first and second pole tips 68 and 70 which are separated by a nonmagnetic gap layer 72.

During recording, flux induced in the first and second pole pieces 56 and 66 by the coil layer 64 is conducted to the pole tips 68 and 70, where the flux flows across the gap layer 72 to magnetically record signals on a rotating magnetic disk 18. During playback, changing magnetic fields on the rotating disk cause a proportional resistance change in the MR sensor 20. A sense current, which is conducted through the MR sensor 20 via the first and second leads 46 and 48, varies proportionately to the change in resistance of the MR sensor 20, thereby allowing detection of the playback signal.

FIGS. 3 and 4 illustrate certain intermediate stages of manufacturing of a singulated slider 14 as shown in FIG. 1. The cutting, polishing, and surface preparation of sliders 14 is commonly referred to as slider fabrication, which may be performed at a different plant from where wafers 102 are fabricated. With reference to FIGS. 1-3, a plurality of MR heads 10 are shown fabricated in rows 80 and columns 82 at the wafer level 100 on a wafer 102 that provides a slider 14 for each MR head 10 after singulation. In actual practice, a significantly greater number of rows 80 and columns than that illustrated in FIG. 3 would be constructed at the wafer level 100, i.e. FIG. 3 is particularly not to scale.

After wafer fabrication, i.e. the formation of the desired thin film layers as discussed with reference to FIG. 2, wafer 102 supporting MR heads 10 is diced along row lines 84 into rows 80a, 80b, and 80c, such as row 80 shown in FIG. 4. Rows 80a, 80b, and 80c show exemplary surface shunting across the singulation lines 86 for respective read-write-write-read (RWWR) MR heads 10a and write-read-read-write (WRRW) MR head 10b. Row 80 in FIG. 4 shows two different types of shunting for convenience. At this stage of the process, referred to as the row level, row 80 of MR heads 10 may be lapped (not shown) across the first and second pole tips 68 and 70 of each MR head 10 for forming desired zero throat heights as shown in FIG. 2. After further processing steps, rows 80 are typically diced by a mechanical dicing blade along singulation lines 86 into individual or singulated sliders 14, which are subsequently polished.

With reference to FIG. 5, each slider 14 containing an MR head 10 is mounted on a head gimbal assembly (HGA) that is then bonded to a suspension. The suspension is bonded to an actuator arm 140 which is then mounted on an actuator spindle 146. A plurality of actuator arms 140 are mounted on the actuator spindle 146 to form a head stack assembly 134. The head stack assembly 134 is later subsequently merged with a disk stack assembly (not shown). The post polishing process is commonly referred to as final assembly, which may be performed at a different plant than slider fabrication.

During construction and assembly of a magnetic disk drive, MR sensor 20 is very vulnerable to electrostatic discharge (ESD) across the read pads 34 and 36. A discharge resulting from a potential built up between the read pads 34 and 36 of less than a volt may be sufficient to destroy or severely damage the MR stripe. In particular, for current GMR a current pulse of less than about 20 milliamps is usually sufficient to induce damage for even short duration current pules. Such a discharge can, for example, occur by contact with or close proximity to a person, plastic involved in the fabrication, or components of a magnetic medium drive. The newer technology TMR heads utilize particularly low currents, are extremely sensitive to ESD, and cannot usually be repaired once they have been electrostatically damaged.

A convenient way of protecting MR sensor 20 from ESD is to interconnect read pads 34 and 36 with a thin film conductive shunt 106 on exterior surface 42 of the MR head 10 as shown in FIGS. 6A and 6B. FIGS. 6A and 6B show respective schematic views of shunting on respective RWWR MR heads 10a and WRRW MR head 10c. WRRW MR heads 10b and 10c may have the same structure but are shunted differently. Skilled persons will appreciate that there are many other possible pad configurations for MR heads 10, such as RRWW or WWRR, and that these MR heads 10 would be shunted differently. Skilled persons will also appreciate that prior art MR heads 10 could be shunted at subsurface levels only so long as the shunt 106 crossed the singulation line 86.

With reference to FIGS. 3, 4 and 6, the conductive shunts 106a, 106b, and 106c (generically shunt 106) connect the MR read pads 34 and 36, which are connected to MR sensor 20 by leads 38 and 40 and first and second leads 46 and 48, to provide a closed circuit for protection from ESD. This shorts the MR circuit, preventing discharge across it. The short circuit created by conductive shunt 106 must, however, be removed at a subsequent stage in the manufacturing process. It is desirable to protect the MR sensor 20 from ESD as early as possible. Although the components of the write head portion are large and typically do not need protection from ESD, the write head components may be shunted across singulation lines 86 as well, or all four pads and metallic interlayers may be shunted together across singulation lines 86 to prevent floating of shields.

FIG. 7 shows an isometric view of the conductive shunt 106. With reference to FIGS. 3, 4, 6 and 7, conductive shunts 106 are connected across the MR read pads 34 and 36 of different MR heads 10. Preferably, conductive shunt 106 is a thin film deposition of gold or copper or other preferably nonmagnetic conductive material. Depending on the configuration of MR head 10, the conductive shunt 106 typically has a length l of about 40-800 μm long between the read pads 34 and 36, has a width w of about 20-60 μm wide, and has a thickness h of about 5-25 μm thick or thicker. For example, the shunt 106 may be as tall as pads 34 and 76 to eliminate additional masking and plating steps. Conductive shunts 106 are typically formed at the wafer level 100 and are severed at a portion 112 during mechanical dicing or singulation. Where mechanical dicing is employed, portion 112 may have a width of about 300 μm wide due to the width of the saw blade. Severance during singulation does not permit shunts 106 to protect MR sensor 20 during subsequent processing or polishing that might induce ESD. In particular, MR sensor 10 is particularly vulnerable to ESD during the steps required to form the head stack assembly 134.

In certain variations, such as MR heads 10c, where shunts 106c do not cross singulation lines 86, conductive shunts 106 can be severed at a portion 112 between read pads 34 and 36 by chemical etching or physical sputtering after head stack assembly 134 has been formed. Both of these methods are cumbersome, and both methods impact the entire MR head 10. When sputtering is employed it is very difficult to avoid damaging MR head 10 and to prevent debris from forming. Debris from the MR head 10 can be especially troublesome because of the potential of contaminating the disk drive.

U.S. Pat. No. 5,759,428 of Balamane et al. discloses a method for forming a reduced-thickness delete pad between read pads 34 and 36 along conductive shunt 106 and then severing the thin delete pad with a laser beam 130 from an infrared (IR) laser 132 after the sliders 14 are mounted in the head stack assembly 134 shown in FIG. 5.

The use of IR laser output to sever such delete pads has serious limitations. The IR laser output cannot be used to cut thick shunts 106 without damaging underlying layers or generating permanent redeposited debris (redep). In addition, the IR laser process must employ numerous low-energy laser pulses and let buried layers cool down between pulses to avoid damage, so the IR laser process is relatively slow. Finally, the IR laser process cannot remove buried shunts since it is transmitted through the alumina and does not ablate it. If IR laser light is employed in an attempt to sever a shunt buried in alumina, the molten material may have no way to be ejected and may cause delamination that destroys the device, or the molten material may destroy the overlying alumina as the metal is ejected.

Consequently, a better method for severing conductive shunts 106 without damaging MR sensors 20 is therefore still desirable to facilitate production of MR heads 10.

### SUMMARY OF THE INVENTION

An object of the present invention is, therefore, to provide a slider head manufacturing method that protects certain magnetic head components from ESD.

Another object of the invention is to provide a laser processing system or method of severing conductive shunts used to protect magnetic head components from ESD.

The present invention employs ultraviolet (UV) laser output to sever a conductive shunt formed across electrically conductive elements of a magnetic head of a slider without damaging the underlayers. The conductive shunt is preferably fabricated from gold, Permalloy, or other appropriate metal and forms a closed circuit with the magnetic head sensor to protect it from damage from electrostatic discharge during polishing and other magnetic head processing steps. The invention also permits buried shunts to be processed and permits the shunts to be positioned across or away from the dice lanes.

Additional objects and advantages of the invention will be apparent from the following detailed description of preferred embodiments thereof, which proceeds with reference to the accompanying drawings.

### BRIEF DESCRIPTION OF THE DRAWINGS

FIG. 1 is a deposited end perspective view of a prior art slider including a magnetic recording head.

FIG. 2 is an enlarged cross-sectional view of a slider with its head oriented toward a magnetic recording disk.

FIG. 3 is an isometric view of rows and columns of magnetic heads formed on a wafer.

FIG. 4 is an isometric view of a row of magnetic heads cut from the wafer shown in FIG. 3.

FIG. 5 is a side elevation view of a head stack assembly that includes a plurality of sliders.

FIG. 6A is an enlarged side elevation view of read pads of two adjacent RWWR heads connected to their MR sensors and shorted by a conductive shunt across a singulation line between two sliders.

FIG. 6B is an enlarged side elevation view of a portion of a slider showing a pair of read pads WRRW head connected to an MR sensor and shorted by a conductive shunt.

FIG. 7 is an enlarged isometric view of the conductive shunt shown in FIG. 5.

FIG. 8 shows graphical representations of the optical absorption properties versus wavelength for common metallic shunt materials.

FIG. 9 presents a transmittance versus wavelength graph for 1-mm thick sapphire.

FIG. 10 shows an embodiment of a laser system employed in connection with the present invention.

FIG. 11A is an enlarged fragmentary cross-sectional side view of a surface shunt positioned above an overcoat layer and an underlying metal layer.

FIG. 11B is an enlarged fragmentary cross-sectional side view of the shunt of FIG. 11A after the shunt has been removed by laser system output.

FIG. 12 is an enlarged plan view of a shunt receiving a pulse of laser system output.

FIG. 13A is an enlarged fragmentary cross-sectional side view of a buried shunt positioned below an additional overcoat layer and above both the primary overcoat layer and an underlying metal layer.

FIG. 13B is an enlarged fragmentary cross-sectional side view of the shunt of FIG. 13A after the shunt has been removed by laser system output.

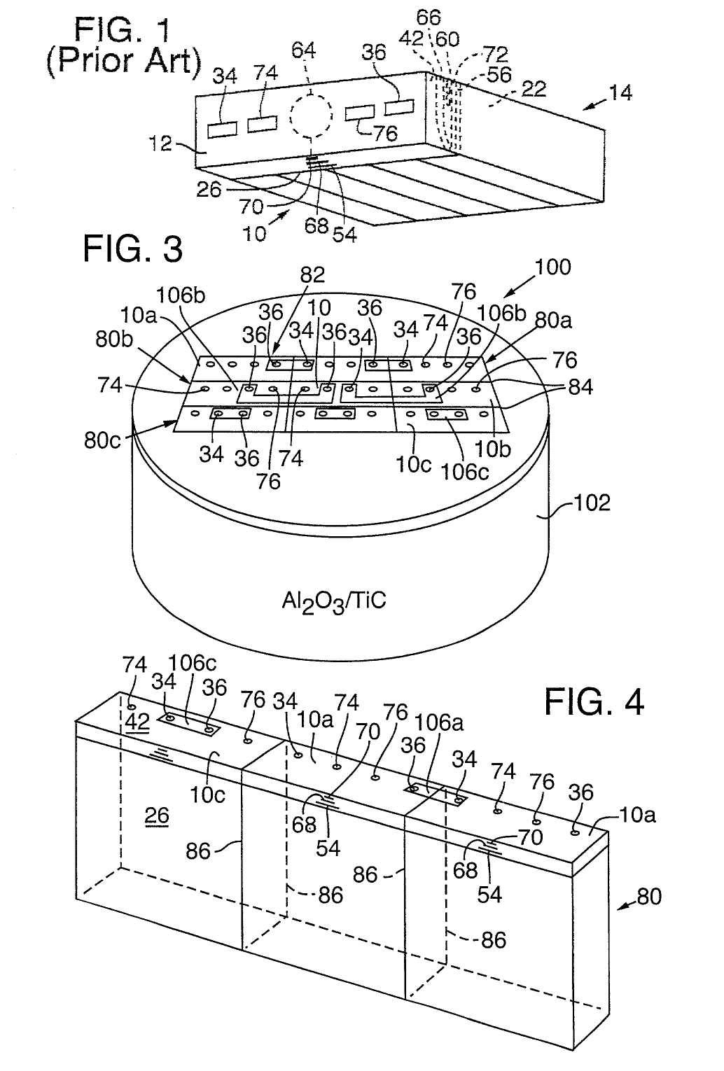

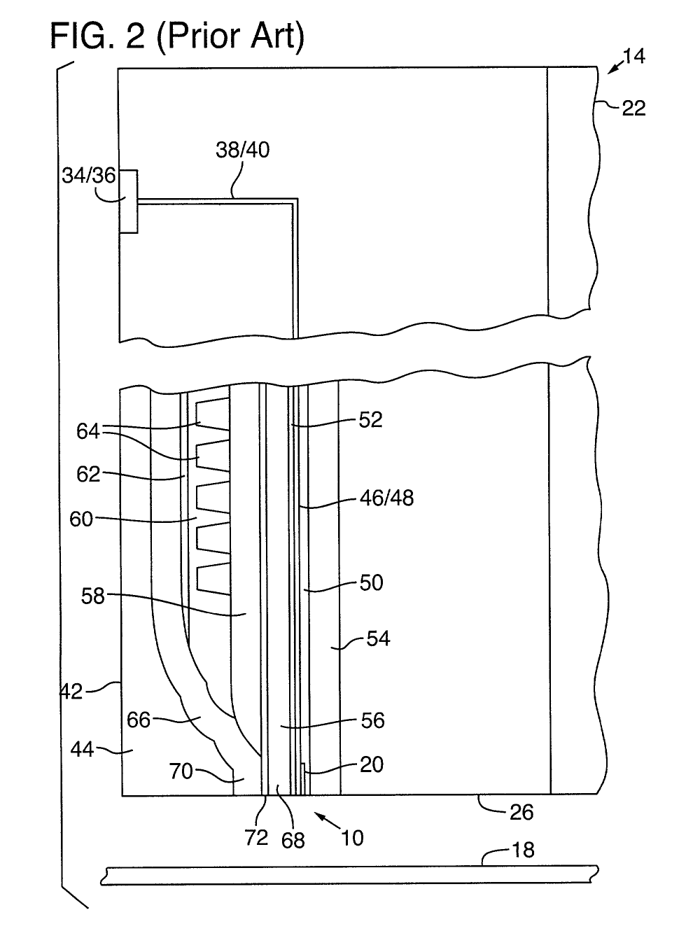

### DETAILED DESCRIPTION OF PREFERRED EMBODIMENTS

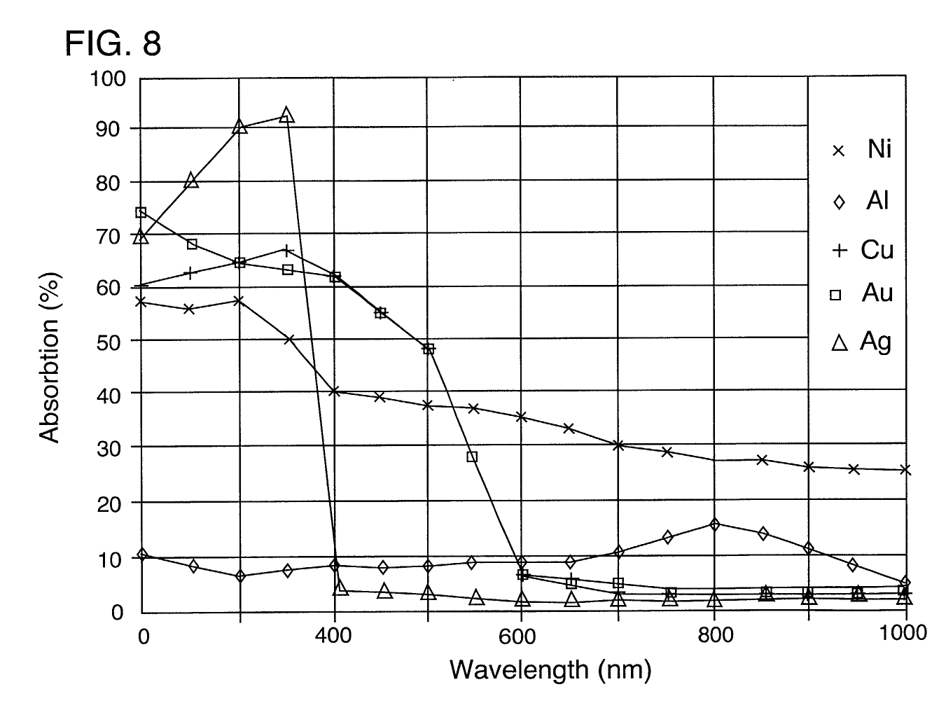

FIG. 8 graphically shows the optical absorption properties of some metals, such as aluminum, copper, gold, nickel, and silver that may be used as links or shunts 106. FIG. 8 is derived from a graph on page 42 of “Ultraviolet Laser Technology and Applications” by David J. Elliot, Academic Press, Inc. 1995. FIG. 8 shows that metals in general absorb laser energy better at UV wavelengths than at IR wavelengths. Other electrically conductive materials, such as iron, Permalloy (NiFe) which is mostly nickel, platinum, or tungsten, or metal nitrides (e.g., titanium nitride or tantalum nitride), can be used to form conductive shunts 106 and generally have similar optical absorption characteristics. Gold, aluminum, or copper are currently the preferred materials for read pads 34 and 36, and shunts 106 are, therefore, preferably made from these same materials to minimize the number of masking and plating steps.

The high absorption of laser wavelengths in the UV wavelength range, and particularly of wavelengths shorter than 300 nm, exhibited by these shunt materials make them more easy to process with UV laser output. Thus, in addition to much better coupling efficiency into conductive shunts 106 to achieve cleaner shunt removal, UV laser output offers a spot size advantage, better open resistance quality across severed shunts 106, and higher shunt processing yields.

Unfortunately, many semiconductor substrates and other slider head fabrication materials are susceptible to damage from laser outputs having either IR or UV wavelengths. In particular, the ceramic wafer material (e.g. AlTiC), the magnetic pole material (e.g. NiFe of various stoichiometries, cobalt based materials, and other magnetic materials and alloys), antiferromagnetic materials (e.g. NiMn, PtMn, PdMn, PtPdMn, etc.), the coil material (e.g. copper), and the insulation materials are all susceptible to damage from laser outputs. Although the optical absorption versus wavelength for some of these materials is not readily available, skilled persons might expect that the absorption coefficients for many of these materials would also increase significantly at some wavelength shorter than 1 μm.

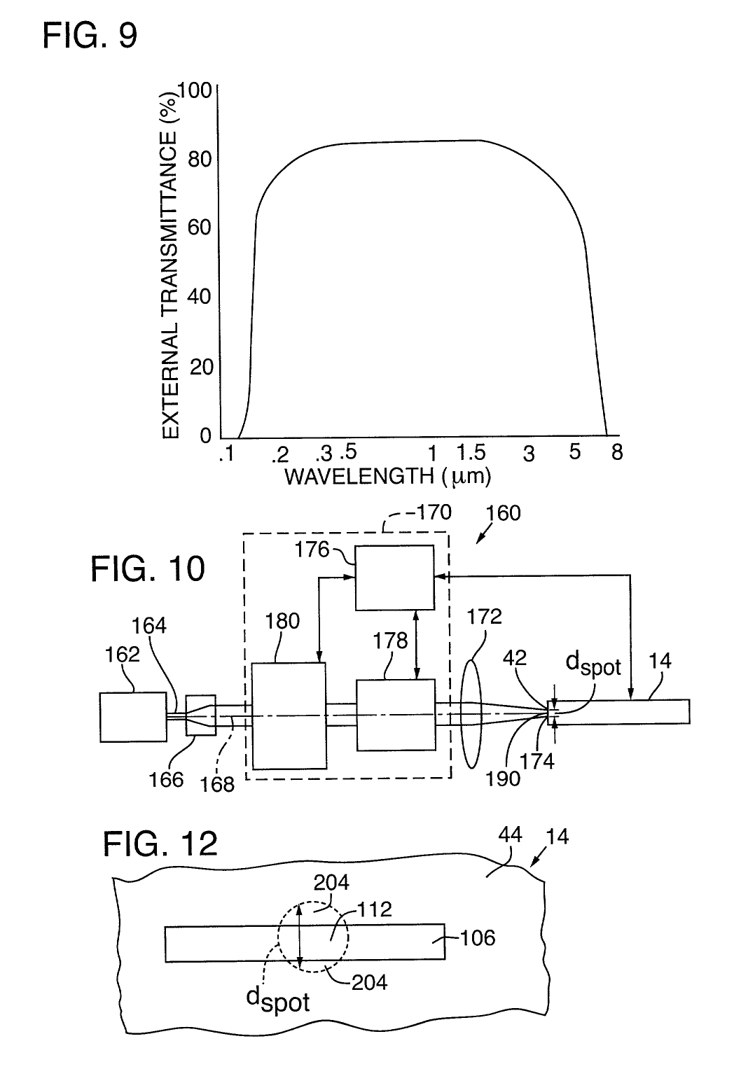

Vacuum-deposited alumina (Al₂O₃) is typically selected as an overcoat layer 44 for MR head 10 because this type of alumina has a favorable thermal expansion coefficient, and the composition of the alumina is primarily determined by its ability to handle mechanical stresses. However, due to the nature of how vacuum-deposited alumina is formed, its optical properties cannot be readily determined and cannot, therefore, be readily looked up in the scientific literature. FIG. 9 presents a transmittance versus wavelength graph for 1-mm thick Al₂O₃ (sapphire). FIG. 9 is derived from FIG. 4.5 on page 4.16 of the Material properties section of a 1999 Melles Griot Catalog. With reference to FIG. 9, the high transmittance (about 80%) of sapphire between about 150-5000 nm suggests that processing alumina with a UV beam at a commercially available wavelength would readily permit damage to underlying slider layers. Thus, skilled practitioners in the laser industry would be unlikely to bother trying laser wavelengths near 266 nm for processing alumina based on the transmittance characteristics of sapphire.

Applicants have determined that like sapphire, vacuum-deposited alumina of overcoat layer 44 is relatively transparent to wavelengths longer than about 350 nm and leaves underlying features susceptible to damage from these laser techniques. However, unlike some other Al₂O₃ compounds such as crystalline sapphire that are transparent at 350 nm and almost transparent at 266 nm, applicants have discovered that vacuum-deposited alumina appears to exhibit better absorption characteristics at some wavelengths shorter than 350 nm, and particularly at some wavelengths shorter than 300 nm. The optical absorption characteristics of vacuum deposited alumina permit shunts 106 on layer 44 or embedded in layer 44 to be advantageously processed by a UV laser system 160.

Vacuum-deposited alumina may also contain dopants or defects that tend to make the alumina layer 44 become relatively absorbing at slightly longer wavelengths, such as about shorter than or equal to 400 nm. For each combination of dopants and/or defects, there may be a different wavelength at which the alumina becomes absorptive. Skilled persons will, therefore, appreciate that a particular dopant and its concentration could be adjusted to “tune” the alumina layer to better absorb a desired UV laser wavelength.

With reference to FIG. 10, a preferred embodiment of a laser system 160 of the present invention includes Q-switched, diode-pumped (DP), solid-state (SS) UV laser 162 that preferably includes a solid-state lasant such as Nd:YAG, Nd:YLF, or Nd:YVO₄, or a YAG crystal. Laser 162 preferably provides harmonically generated UV laser output 164 of one or more laser pulses at a wavelength such as 266 nm (frequency quadrupled Nd:YAG) or 213 nm (frequency quintupled Nd:YAG) with primarily a TEM₀₀ spatial mode profile.

Skilled persons will appreciate that other wavelengths are available from the other listed lasants. Laser cavity arrangements, harmonic generation, and Q-switch operation are all well known to persons skilled in the art. Details of one exemplary laser 162 and laser ablation pulse parameters for ablating metals and other materials are described in detail in U.S. Pat. No. 5,593,606 of Owen et al. Skilled persons will also appreciate that excimers and other types of commercially available lasers can provide laser output at a preferred wavelength shorter than 350 nm.

UV laser pulses 164 may be converted or expanded by a variety of well-known optics 166, such as beam expander or upcollimator lens components that are positioned along beam path 168, and are directed by a beam positioning system 170 and through an objective scan or cutting lens 172 to a desired laser target position 174, such as a conductive shunt 106 on a workpiece such as slider 14.

Beam positioning system 170 preferably includes a translation stage positioner 176 and a fast positioner 178. Translation stage positioner 176 employs at least two platforms or stages that support, for example, X, Y, and Z positioning mirrors and permit quick movement between target positions 174 on the same or different sliders 14. In a preferred embodiment, translation stage positioner 176 is a split-axis system where a Y stage, typically moved by linear motors, supports and moves slider 14; an X stage supports and moves fast positioner 178 and objective lens 172; the Z dimension between the X and Y stages is adjustable; and fold mirrors 180 align the beam path 168 through any turns between laser 162 and fast positioner 178. Fast positioner 178 may for example employ high resolution linear motors or a pair of galvanometer mirrors that can effect unique or duplicative processing operations based on provided test or design data. These positioners can be moved independently or coordinated to move together in response to panelized or unpanelized data.

Such a preferred beam positioning system 170 that can be used for present application is described in detail in U.S. Pat. No. 5,751,585 of Cutler et al. Other preferred positioning systems such as Model series numbers 27xx, 43xx, 44xx,or 53xx, manufactured by Electro Scientific Industries, Inc. in Portland, Oreg., can also be employed. Some of these systems which use an X-Y linear motor for moving the workpiece and an X-Y stage for moving the scan lens are cost effective positioning systems for making long straight cuts. Skilled persons will also appreciate that a system with a single X-Y stage for workpiece positioning with a fixed galvanometer for beam positioning may alternatively be employed.

A laser controller (not shown) that directs the movement of the beam positioning components preferably synchronizes the firing of laser 162 to the motion of the components of beam positioning system 170 such as described in U.S. Pat. No. 5,453,594 of Konecny for Radiation Beam Position and Emission Coordination System. An example of a preferred laser system 160 that contains many of the above-described system components are Models 2700 or 4440 or others in its series sold by Electro Scientific Industries, Inc. in Portland, Oreg.

Beam positioning system 170 can employ conventional vision or beam to work alignment systems that work through objective lens 172 or off axis with a separate camera and that are well known to skilled practitioners. In one embodiment, a vision box employing Freedom Library software in a positioning system manufactured by Electro Scientific Industries, Inc. is employed to perform alignment between laser system output 190 of laser system 160 and target locations 174 on sliders 14. The alignment system preferably employs bright-field, on-axis illumination, particularly for specularly reflecting workpieces like lapped or polished sliders 14. There are a large number of features on MR head 10 to which the alignment system can be correlated, alignment techniques are well known in the laser art, and many suitable alignment systems are commercially available.

Lens 172 may employ an F1, F2, or F3 single component or multicomponent lens system that focuses the UV pulsed output 164 to produce a focused spot size, dₛₚₒₜ, for each pulse of laser system output 190 that is smaller than the distance between the read pads 34 and 36, which is typically less than a few hundred microns and is more typically in the range of 10-20 μm. The focused spot size is preferably in the range of about 1-100 μm, more preferably in the range of about 5-30 μm, and most preferably in the range of about 10-20 μm. Skilled persons will appreciate that spot size values outside these ranges could be employed with smaller values being largely determined by the laser processing window and the larger values being largely determined by the shunt structure geometry.

The focused laser spot is directed over wafer 102 to target shunt 106 to preferably sever it with a single pulse of UV laser system output 190. The severing depth of each pulse of laser system output 190 applied to shunt 106 can be accurately controlled by choosing the energy of the pulse. Preferred removal portions 112 of shunt are from about 0.05-40 μm thick, and most preferably from about 5-20 μm thick and made from gold. In general, preferred ablation parameters of focused spot size (e.g., 12 μm) of laser system output 190 include pulse energies of sufficient energy/fluence to remove delete pad, such as from about 1-200 μJ, more preferably greater than 20 μJ, and most preferably from about 30-100 μJ, a pulse duration from about 1-100 ns , and preferably from 20-50 ns (e.g. 25-45 ns) at greater than or equal to 5 kHz, and most preferably from 12-14 kHz or greater. A preferred wavelength is about 266 nm because it is easy to generate, and at 355 nm, enough laser energy may pass through the alumina to be absorbed by an underlying metal layer to cause delamination of the magnetic head 10.

Alumina overcoat layer 44 beneath shunt 106 is preferably at least about 1-1.5 times thicker than the thickness for a thick metal shunt 106 that has a thickness of greater than about 2 μm. The preferred alumina overcoat layer 44 has a thickness of 5-40μm. However, thinner shunts 106 and certain shunt materials may be severed with less laser energy over a thinner alumina layer 44.

The shunt severing process can be accomplished with a single pulse process, a single or multiple pass punching process (preferably two overlapping pulses), single or multiple pass nibbling (typically with a bite size of about 1-12 μm, and preferably less than about 10 μm, at a speed of about 70-140 mm/sec) with 1-3 passes being preferred, or using one or more a bursts of picosecond pulses in any of the aforementioned severing techniques. The use of bursts of UV picosecond pulses to sever metallic links is described in detail in International Publication No. WO 01/51243 A2. Employing multiple passes has the advantage of better depth control.

Although a beam spot having a traditional Gaussian irradiance profile may be employed, a clipped-Gaussian imaging irradiance profile well known to skilled practitioners can also be employed. In addition, an imaged shaped Gaussian beam can be employed to provide a beam spot with substantially uniform “tophat” irradiance profile. In one embodiment of the invention, a UV DPSS laser system is equipped with a diffractive optical element (DOE) to shape the raw laser Gaussian irradiance profile into a “top hat” or predominantly substantially uniform irradiance profile. The resulting shaped laser output is then clipped by an aperture or mask to provide an imaged shaped output beam. This technique is described in detail in International Publication No. WO 00/73103 published on Dec. 7, 2000. Employing such an imaged shaped Gaussian beam facilitates more precise depth control.

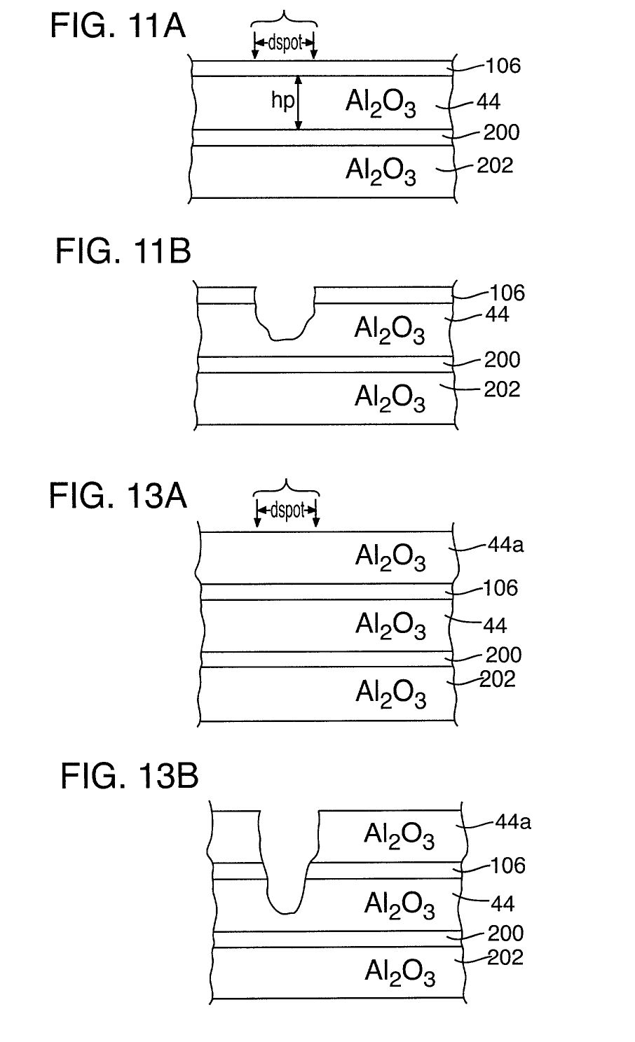

FIG. 11A is an enlarged fragmentary cross-sectional side view of shunt 106 receiving a laser system output 190 characterized by pulse parameters previously discussed; FIG. 11B is an enlarged fragmentary cross-sectional side view of the shunt 106 of FIG. 11A after it has been severed by laser system output 190; and FIG. 12 is an enlarged plan view of a shunt 106 receiving a pulse of laser system output 190. Shunts 106 can form part MR heads 10 of any configuration (e.g. WRRW, RWWR, WWRR, RRWW, etc.) and can be positioned across the singulation lines 86. And unlike for most prior art MR heads 10, shunts 106 can be positioned such that they do not cross singulation lines 86, and can further be positioned over critical MR head layers and materials that are susceptible to damage from laser light.

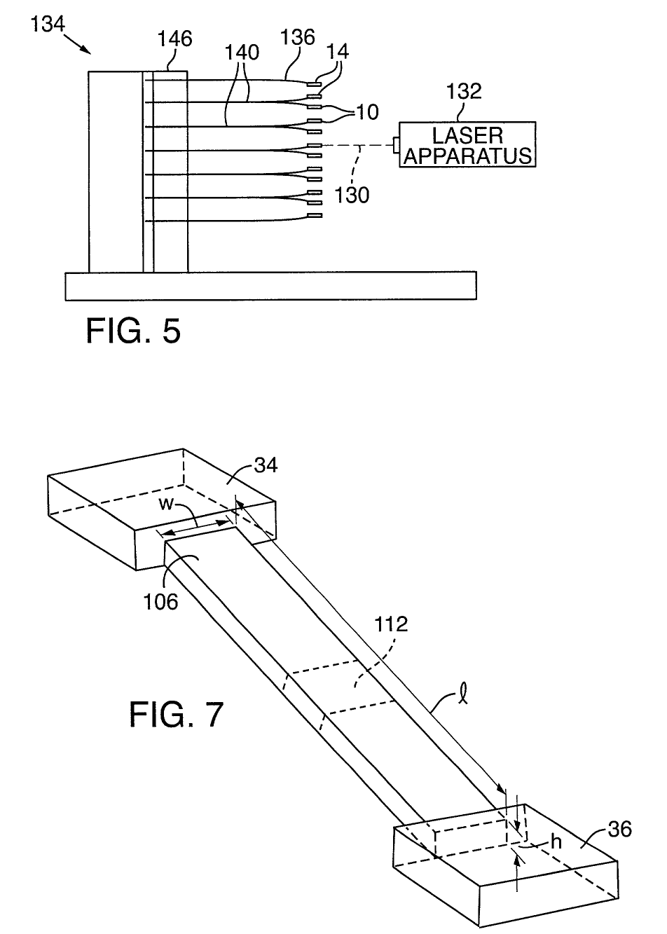

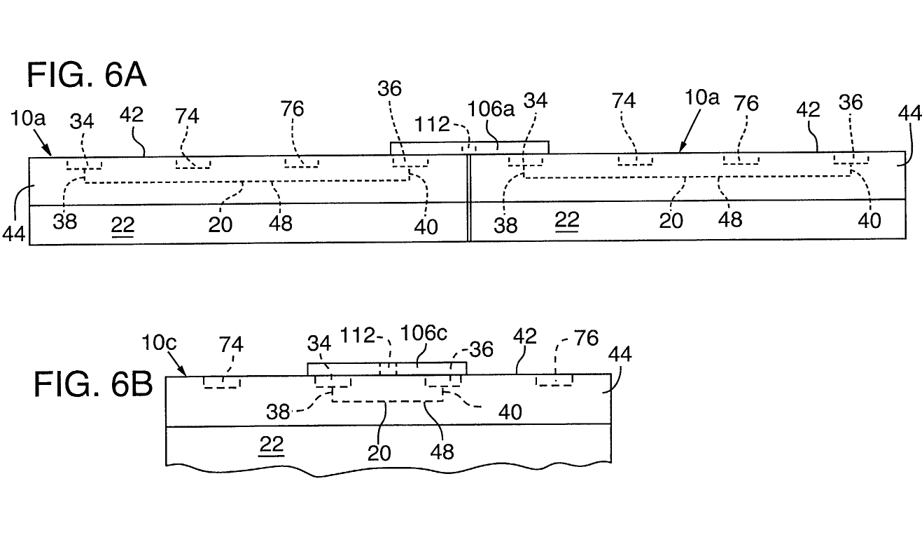

With reference to FIGS. 3-7, 11A, 11B, and 12, the overcoat layer 44 preferably has a height, hp, large enough to attenuate by a sufficient amount, the UV laser energy used to sever shunt 106 so that underlying UV-sensitive component layer(s) 200, such as metal layers, and lower undercoat layer 202, such as alumina, will not be damaged and no delamination of MR head 14 will occur. For an overcoat layer 44 comprising alumina, the height is preferably at least about 0.5-1 μm for thinner shunts 106, and more preferably at least about 5 μm for thicker shunts. The height of layer 44 can be adjusted so that its off-shunt portions 204 within the spot area attenuate sufficient energy from the pulse to protect the off-shunt portions of underlying features. For example, the alumina layer 44 can be made thicker (higher), if desirable, to prevent any UV laser energy from reaching the underlying component layers 200 or from causing delamination. Similarly, the height of one or more subsurface layers 202 can also be adjusted. An additional absorptive shield layer (not shown) can be employed to prevent transmission of UV laser energy to the underlying component layers 200. Some of these techniques for adjusting the height of a passivation layer are disclosed in U.S. Pat. No. 6,057,180 of Sun et al.

In U.S. Pat. No. 6,057,180, Sun et al. employed UV laser output to exploit the absorption characteristics of the materials from which an electrically conductive link, an underlying semiconductor substrate, and passivation layers including an inorganic dielectric such as silicon dioxide or silicon nitride, were made to effectively sever the link without damaging the substrate. The UV laser output formed smaller than conventional IR laser link-blowing spot diameters because of its shorter wavelength, and thereby permitted the implementation of greater circuit density. The passivation layer positioned between the link and the substrate could be formulated to be sufficiently absorptive to UV laser energy and sufficiently thick to attenuate the laser energy to prevent it from damaging the substrate in the laser beam spot area. The UV laser output controllably ablated a depthwise portion of the passivation layer underlying the link to facilitate complete removal of the link. In addition, direct ablation of the passivation layer with the Uv laser output facilitated predictable and consistent link severing profiles. Skilled persons will appreciate, however, that the absorption and ablation characteristics of alumina at a commercially useful laser wavelength below 350 nm could not be predicted and the ablation behavior was unexpected. Skilled persons will also appreciate that the slider manufacturing industry is not analogous art to the memory repair industry.

In addition to the advantages of UV utilization previously discussed, overcoat layer 44 permits other processing advantages. For example, the height can be adjusted to permit intentional partial ablation of overcoat layer 44 as shown in FIG. 11B. The partial ablation of overcoat layer 44 facilitates complete removal of the bottom of removal portions 112 of shunts 106 without risk of damage to underlying layers 200 to achieve a high open resistance across read pads 34 and 36.

UV laser severing of shunt 106 in accordance with the present invention can be performed at any stage of the head manufacturing process, such as during or after wafer fabrication, slider fabrication, or final assembly, whereas most prior art shunt severing was designed to occur during slider singulation. Thus, most prior art sliders could not be protected from ESD during polishing or final assembly. Shunts 106 are preferably severed after construction of head stack assembly 134.

Skilled persons will appreciate that it might be desirable to sever shunts 106 during an earlier stage of manufacturing, particularly for testing the performance or viability for each MR head 10. Conventional testing of MR heads 10, if performed at all, was performed after shunts 106 were severed during singulation. The present invention permits, however, for MR heads 10 to be tested prior to singulation or prior to row separation. Batch testing of a full wafer 102 of attached MR heads 10 rather than singulated MR heads 10 could have significant processing cost and processing time advantages.

The present invention also permits reconnection of severed shunts 106 for further processing after testing and sorting. Metal deposition and via metalization techniques are well known in the semiconductor manufacturing industry. Although a batch reflow process would be preferred if possible, severed shunts 106 could be individually reconnected using a UV laser wavelength shorter than 350 nm, and preferably shorter than 300 nm, such as at about 266 nm or at the other preferred wavelengths previously discussed. In particular, longer pulsewidths, lower energies at higher repetition rates and higher scan speeds are desirable for reflow, and other laser types such as excimers may be preferred for the reflow process. Shunts 106 could thereby be reformed and re-severed as desirable to accommodate testing and protection at several stages during the manufacturing process, thereby eliminating the expense and time for processing nonfunctional MR heads 10.

FIG. 13A is an enlarged fragmentary cross-sectional side view of a buried shunt 106a positioned below an additional overcoat layer 44a and above both overcoat layer 44 layer and an underlying metal layer 200; and FIG. 13B is an enlarged fragmentary cross-sectional side view of the shunt 106a of FIG. 13A after it has been removed by laser system output 190. With reference to FIGS. 13A and 13B, laser system output 190 can be tailored to remove the additional overcoat layer 44b as well as sever a shunt 106 lying beneath it. Buried shunt processing can be accomplished regardless of the thickness of layer 44a or the thickness of shunt 106a; however, the heights of the various layers can be adjusted to enhance throughput, maximize damage protection, or facilitate lower layer level processing.

Shunts 106a can form part MR heads 10 of any configuration (e.g. WRRW, RWWR, WWRR, RRWW, etc.) and can be positioned across the singulation lines 86. And unlike for most prior art MR heads 10, shunts 106a can be positioned such that they do not cross singulation lines 86, and can further be positioned over critical MR head layers 200 and materials that are susceptible to damage from laser light. Since shunts 106a are buried they are typically shorter in height than about 5 μm and preferably shorter in height than about 0.5 μm. Buried shunts 106a can be used to connect read pads 34 and 36 and/or write pads 74 and 76, conductive and/or magnetic interlayers, multiple sensors 20, and/or numerous combinations or variations of these components. Conductive or magnetic interlayers may be connected, for example, to prevent soft ESD failure or a backward bias, or all layers may be shunted together to prevent floating potentials. Shunts 106a can also take the form of lines that exist as base plating straps. In addition, the ability to process buried shunts 106a permits redundant sensors 20 or other redundant components to be built into MR heads 10 such the nonfunctional elements can be disconnected with laser output 190, such as is done in the semiconductor memory repair industry. Redundancy is not currently designed into MR heads 10.

In addition to shunt severing, the parameters of UV laser system output 190 can also be used to cut alumina. For example, laser system output 190 can be used to clean alumina off of or away from bond pads, or for notching alumina, such as for a pre-dicing step. Slider cutting techniques are disclosed in detail in U.S. patent application Ser. No. 09/803,382 of Fahey et al., the relevant disclosure of which is herein incorporated by reference.

It will be obvious to those having skill in the art that many changes may be made to the details of the above-described embodiments of this invention without departing from the underlying principles thereof. The scope of the present invention should, therefore, be determined only by the following claims.

1. A method for processing a magneto-resistive head having a conductive shunt between two metallic read pads in communication with a magnetic sensor of a thin film magnetic head such that the conductive shunt is in electrical contact with the metallic pads to create a short circuit that protects the magneto-resistive head from electrostatic discharge, comprising:
generating and directing UV laser system output having a wavelength shorter than 350 nm toward the conductive shunt; and
severing the conductive shunt with the UV laser system output to eliminate the short circuit between the metallic pads.

2. The method of claim 1 in which the conductive shunt is formed on a surface of a passivation layer and has an exposed surface.

3. The method of claim 2 in which the passivation layer comprises deposited alumina.

4. The method of claim 1 in which the conductive shunt is buried within a passivation layer.

5. The method of claim 4 in which the passivation layer comprises deposited alumina.

6. The method of claim 5 in which magneto-resistive head comprises at least one head component that is positioned beneath the conductive shunt and is susceptible to damage from ultraviolet laser system output.

7. The method of claim 3 in which the continuous contact pad member comprises a height of greater than 5 μm.

8. The method of claim 7 in which the continuous contact pad member comprises a height of greater than about 10 μm.

9. The method of claim 3 in which the conductive shunt comprises gold.

10. The method of claim 5 in which the conductive shunt comprises gold.

11. The method of claim 7 in which the conductive shunt comprises gold.

12. The method of claim 1 in which the UV laser system output comprises a wavelength shorter than about 266 nm.

13. The method of claim 3 in which the UV laser system output comprises a wavelength shorter than or equal to about 266 nm.

14. The method of claim 5 in which the UV laser system output comprises a wavelength shorter than or equal to about 266 nm.

15. The method of claim 7 in which the UV laser system output comprises a wavelength shorter than or equal to about 266 nm.

16. The method of claim 11 in which the UV laser system output comprises a wavelength shorter than or equal to about 266 nm.

17. The method of claim 13 in which a solid-state laser system generates the UV laser system output.

18. The method of claim 14 in which a solid-state laser system generates the UV laser system output.

19. The method of claim 15 in which a solid-state laser system generates the UV laser system output.

20. The method of claim 16 in which a solid-state laser system generates the UV laser system output.

21. The method of claim 20 in which the UV laser system output comprises a spot size between about 5-30 μm, a pulse energy of greater than about 20 μJ, and a repetition rate of greater than about 5 kHz.

22. The method of claim 17 in which the UV laser system output comprises at least two laser pulses.

23. The method of claim 18 in which the UV laser system output comprises at least two laser pulses.

24. The method of claim 20 in which the UV laser system output comprises at least two laser pulses.

25. The method of claim 1 in which the UV laser system output is generated after the magneto-resistive head is polished.

26. The method of claim 20 in which the UV laser system output is generated after the magneto-resistive head is polished.

27. The method of claim 1 in which the UV laser system output is generated after the magneto-resistive head is assembled into a head stack assembly.

28. The method of claim 20 in which the UV laser system output is generated after the magneto-resistive head is assembled into a head stack assembly.

29. The method of claim 1 in which the conductive shunt is positioned such that it is distant from and nonoverlapping with a dicing line.

30. The method of claim 3 in which the conductive shunt is positioned such that it is distant from and nonoverlapping with a dicing line.

31. The method of claim 5 in which the conductive shunt is positioned such that it is distant from and nonoverlapping with a dicing line.

32. The method of claim 20 in which the conductive shunt is positioned such that it is distant from and nonoverlapping with a dicing line.

33. The method of claim 13 in which an excimer laser system generates the UV laser system output.

34. The method of claim 14 in which an excimer laser system generates the UV laser system output.

35. The method of claim 3 further comprising:
testing the magnetic head;
reconnecting the shunt;
further processing the slider; and
re-severing the shunt.

36. The method of claim 5 further comprising:
testing the magnetic head;
reconnecting the shunt;
further processing the slider; and
re-severing the shunt.

37. The method of claim 20 further comprising:
testing the magnetic head;
reconnecting the shunt;
further processing the slider; and
re-severing the shunt.

38. The method of claim 17 in which the laser system output has a clipped Gaussian irradiance profile or an imaged shaped Gaussian irradiance profile.

39. The method of claim 18 in which the laser system output has a clipped Gaussian irradiance profile or an imaged shaped Gaussian irradiance profile.

40. The method of claim 19 in which the laser system output has a clipped Gaussian irradiance profile or an imaged shaped Gaussian irradiance profile.

41. The method of claim 21 in which the laser system output has a clipped Gaussian irradiance profile or an imaged shaped Gaussian irradiance profile.

42. A method for processing a thin film magnetic head having a conductive shunt between two electrically conductive components such that the conductive shunt is in electrical contact with the electrically conductive components to create a short circuit that protects the magnetic head from electrical damage, comprising:
generating and directing UV laser system output having a wavelength shorter than 350 nm toward a conductive shunt buried beneath a deposited alumina layer and positioned above another head component susceptible to damage from ultraviolet laser system output; and
severing the conductive shunt with the UV laser system output to eliminate the short circuit between the electrically conductive components.

43. The method of claim 42 in which the UV laser system output comprises a wavelength shorter than or equal to about 266 nm.

44. The method of claim 43 in which the conductive shunt comprises gold.

45. The method of claim 43 in which a solid-state laser system generates the UV laser system output.

46. The method of claim 42 in which an excimer laser system generates the UV laser system output.

47. The method of claim 43 in which the UV laser system output comprises a spot size between about 5-30 μm, a pulse energy of greater than about 20 μJ, and a repetition rate of greater than about 5 kHz.

48. The method of claim 43 in which the UV laser system output comprises at least two laser pulses.

49. The method of claim 47 in which the UV laser system output comprises at least two laser pulses.

50. The method of claim 42 in which the UV laser system output is generated after the magneto-resistive head is polished.

51. The method of claim 43 in which the UV laser system output is generated after the magneto-resistive head is polished.

52. The method of claim 49 in which the UV laser system output is generated after the magneto-resistive head is polished.

53. The method of claim 42 in which the conductive shunt is positioned such that it is distant from and nonoverlapping with a dicing line.

54. The method of claim 43 in which the conductive shunt is positioned such that it is distant from and nonoverlapping with a dicing line.

55. The method of claim 47 in which the conductive shunt is positioned such that it is distant from and nonoverlapping with a dicing line.

56. The method of claim 42 further comprising:
testing the magnetic head;
reconnecting the shunt;
further processing the slider; and
re-severing the shunt.

57. The method of claim 43 further comprising:
testing the magnetic head;
reconnecting the shunt;
further processing the slider; and
re-severing the shunt.

58. The method of claim 47 further comprising:
testing the magnetic head;
reconnecting the shunt;
further processing the slider; and
re-severing the shunt.

59. The method of claim 42 in which the laser system output has a clipped Gaussian irradiance profile or an imaged shaped Gaussian irradiance profile.

60. The method of claim 43 in which the laser system output has a clipped Gaussian irradiance profile or an imaged shaped Gaussian irradiance profile.

61. The method of claim 47 in which the laser system output has a clipped Gaussian irradiance profile or an imaged shaped Gaussian irradiance profile.

62. The method of claim 58 in which the laser system output has a clipped Gaussian irradiance profile or an imaged shaped Gaussian irradiance profile.
